(19) United States
(12) Patent Application Publication
(10) Pub. No.: US 2006/0009172 A1
(43) Pub. Date: Jan. 12, 2006

(54) Feed forward amplifier with multiple cancellation loops capable of reducing intermodulation distortion and receive band noise

(76) Inventor: Khosro Shamsaifar, Ellicott City, MD (US)

Correspondence Address: James S. Finn;C/O William Tucker, 14431 Goliad Dr., Box #8, Malakoff, TX, 75148, US

(21) Appl. No.: 11/153,813

(22) Filed: Jun. 15, 2005

Related U.S. Application Data
(60) Provisional application No. 60/586,437, filed on Jul. 8, 2004.

(51) Int. Cl. H04B 1/04; H04K 1/02; H04L 25/03

(52) U.S. Cl. 455/114.2; 375/296

(57) ABSTRACT

An embodiment of the present invention provides an apparatus, comprising a feed forward amplifier capable of receiving an input signal and including a plurality of cancellation loops, wherein at least one of the cancellation loops includes a tunable delay line enabling the reduction of intermodulation distortion and receive band noise when outputs from the plurality of cancellation loops are combined with the input signal to the feed forward amplifier. In an embodiment of the present invention the plurality of cancellation loops may be two cancellations loops and a tunable delay line may be included in both of the cancellation loops. Further, the tunable delay line may be a voltage tunable delay line that includes a voltage tunable dielectric capacitor to facilitate the control of the tunable delay and the voltage tunable dielectric capacitor may include a layer of voltage tunable dielectric material positioned on a surface of a low loss, low dielectric substrate.

### CROSS REFERENCED TO RELATED APPLICATIONS

This application is a continuation-in-part of co-pending patent application with attorney docket number JSF01-0088/WJT08-0093 entitled, “METHOD AND APPARATUS CAPABLE OF INTERFERENCE CANCELLATION” filed, Jun. 14, 2006 and claims the benefit of U.S. Provisional Patent Application Ser. No. 60/586,437 filed Jul. 08, 2004.

### BACKGROUND OF THE INVENTION

Electrically tunable filters have many uses in microwave and radio frequency systems. Compared to mechanically and magnetically tunable filters, electronically tunable filters have the important advantage of fast tuning capability over wide band application. Because of this advantage, they can be used in the applications such as, by way of example and not by way of limitation, LMDS (local multipoint distribution service), PCS (personal communication system), frequency hopping, satellite communication, and radar systems.

Filters for use in radio link communications systems have been required to provide better performance with smaller size and lower cost. Significant efforts have been made to develop new types of resonators, new coupling structures and new configurations for the filters. In some applications where the same radio is used to provide different capacities in terms of Mbits/sec, the intermediate frequency (IF) filter's bandwidth has to change accordingly. In other words, to optimize the performance of radio link for low capacity radios, a narrow band IF filter is used while for higher capacities wider band IF filters are needed. This requires using different radios for different capacities, because they have to use different IF filters. However, if the bandwidth of the IF filter could be varied electronically, the same configuration of radio could be used for different capacities which will help to simplify the architecture of the radio significantly, as well as reduce cost.

Traditional electronically tunable filters use semiconductor diode varactors to change the coupling factor between resonators. Since a diode varactor is basically a semiconductor diode, diode varactor-tuned filters can be used in various devices such as monolithic microwave integrated circuits (MMIC), microwave integrated circuits or other devices. The performance of varactors is defined by the capacitance ratio, C.sub.max/C.sub.min, frequency range, and figure of merit, or Q factor at the specified frequency range. The Q factors for semiconductor varactors for frequencies up to 2 GHz are usually very good. However, at frequencies above 2 GHz, the Q factors of these varactors degrade rapidly.

Since the Q factor of semiconductor diode varactors is low at high frequencies (for example, <20 at 20 GHz), the insertion loss of diode varactor-tuned filters is very high, especially at high frequencies (>5 GHz). Another problem associated with diode varactor-tuned filters is their low power handling capability. Further, since diode varactors are nonlinear devices, their handling of signals may generate harmonics and subharmonics.

Commonly owned U.S. patent application Ser. No. 09/419,219, filed Oct. 15, 1999, and titled “Voltage Tunable Varactors And Tunable Devices Including Such Varactors”, discloses voltage tunable dielectric varactors that operate at room temperature and various devices that include such varactors, and is hereby incorporated by reference. Compared with the traditional semiconductor diode varactors, dielectric varactors have the merits of lower loss, higher power-handling, higher IP3, and faster tuning speed.

High power amplifiers are also an important part of any radio link. They are required to output maximum possible power with minimum distortion. One way to achieve this is to use feed forward amplifier technology. A typical feed forward amplifier includes two amplifiers (the main and error amplifiers), directional couplers, delay lines, gain and phase adjustment devices, and loop control networks. The main amplifier generates a high power output signal with some distortion while the error amplifier produces a low power distortion-cancellation signal.

In a typical feed forward amplifier, a radio frequency (RF) signal is input into a power splitter. One part of the RF signal goes to the main amplifier via a gain and phase adjustment device. The output of the main amplifier is a higher level, distorted carrier signal. A portion of this amplified and distorted carrier signal is extracted using a directional coupler, and after going through an attenuator, reaches a carrier cancellation device at a level comparable to the other part of the signal that reaches carrier cancellation device after passing through a delay line. The delay line is used to match the timing of both paths before the carrier cancellation device. The output of carrier cancellation device is a low level error or distortion signal. This signal, after passing through another gain and phase adjustment device, gets amplified by the low power amplifier. This signal is then subtracted from the main distorted signal with an appropriate delay to give the desired non-distorted output carrier.

Traditionally, delay lines have been used to give the desired delay and provide the above-described functionality. However, delay filters have become increasingly popular for this application because they are smaller, easily integrated with other components, and have lower insertion loss, as compared to their delay line counterpart. A fixed delay filter can be set to give the best performance over the useable bandwidth. This makes the operation of a feed forward amplifier much easier, as compared to the tuning of a delay line, which simulates adjustment of the physical length of a cable. However, fixed delay filters still have to be tuned manually.

There is a need for high performance, small size tunable bandwidth filters for wireless communications applications, as well as other applications. There is a further need for a method and apparatus capable of interference cancellation.

### SUMMARY OF THE INVENTION

An embodiment of the present invention provides an apparatus, comprising a feed forward amplifier capable of receiving an input signal and including a plurality of cancellation loops, wherein at least one of the cancellation loops includes a tunable delay line enabling the reduction of intermodulation distortion and receive band noise when outputs from the plurality of cancellation loops are combined with the input signal to the feed forward amplifier. In an embodiment of the present invention the plurality of cancellation loops may be two cancellations loops and a tunable delay line may be included in both of the cancellation loops. Further, the tunable delay line may be a voltage tunable delay line that includes a voltage tunable dielectric capacitor to facilitate the control of the tunable delay and the voltage tunable dielectric capacitor may include a layer of voltage tunable dielectric material positioned on a surface of a low loss, low dielectric substrate. The voltage tunable dielectric capacitor may further include a pair of electrodes positioned on the layer of voltage tunable dielectric material and separated by a gap, with an input line connected with a first electrode of the pair of electrodes and an output line connected with a second electrode of the pair of electrodes. Further, the voltage tunable dielectric capacitor may include a variable DC voltage source connected between the pair of electrodes to supply a control voltage to the voltage tunable dielectric capacitor.

In an embodiment of the present invention, the present invention may further comprise an input signal, the input signal including a receive band noise component and an intermodulation interference component and wherein the enabling of the reduction of intermodulation distortion and receive band noise when the plurality of cancellation loops are combined is accomplished by the tunable delay line of the first cancellation loop delaying the noise component by 180 degrees of the input signal and the delay line of the second cancellation loop delaying the intermodulation interference component by 180 degrees such that when the input signal and the signals from the first and the second cancellation loops are combined, the noise signal component and the intermodulation signal component are cancelled from the input signal.

An embodiment of the present invention also provides a method of reducing intermodulation distortion and receive band noise in a signal that is input into a feed forward amplifier, comprising applying a first cancellation loop to the input signal, the first cancellation loop including a tunable delay line capable of delaying a noise component to the input signal, applying a second cancellation loop to the input signal, the second cancellation loop including a tunable delay line capable of delaying an intermodulation noise component to the input signal, and combining the input signal and the output of the first cancellation loop and the output of the second cancellation loop to produce an output signal with reduced noise and intermodulation interference.

Yet another embodiment of the present invention provides a system, comprising a feed forward amplifier with an input signal and an output signal and a plurality of cancellation loops integral to the feed forward amplifier, wherein each of the plurality of cancellation loops contains a tunable delay line capable of adjusting the phase of the input signal and recombining with the input signal such that any interference included in the input signal or generated by the feed forward amplifier is removed prior to the output signal.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 is a schematic representation of a lumped element tunable bandwidth band-pass filter constructed in accordance with this invention.

FIG. 2 is a schematic representation of an edged coupled microstrip line band-pass filter with tunable varactors.

FIG. 3 is a top plan view of a varactor that can be used in the filters of this invention.

FIG. 4 is a cross-sectional view of the varactor of FIG. 3, taken along section 4-4 of FIG. 3.

FIG. 5 is a schematic representation of feed forward amplifier that uses a tunable delay filter in accordance with this invention.

FIG. 6 is a flow diagram illustrating the method of the present invention.

FIG. 7 illustrates a signal spectrum at the input which includes a transmit signal and receive noise of one embodiment of the present invention.

FIG. 8 illustrates a signal spectrum at point “a” of FIG. 12 including a transmit signal and receive noise and intermodulation signals one embodiment of the present invention.

FIG. 9 illustrates the signal spectrum at point “b” of FIG. 12 and intermodulation signals of one embodiment of the present invention.

FIG. 10 illustrates the Signal spectrum at point “c” of FIG. 12 with Transmit signal and Receive noise amplified of one embodiment of the present invention.

FIG. 11 illustrates the signal spectrum at point “d” of FIG. 12 with receive noise of one embodiment of the present invention.

FIG. 12 illustrates a feed forward power amplifier capable of reducing intermodulation distortion and receive noise of one embodiment of the present invention.

### DETAILED DESCRIPTION

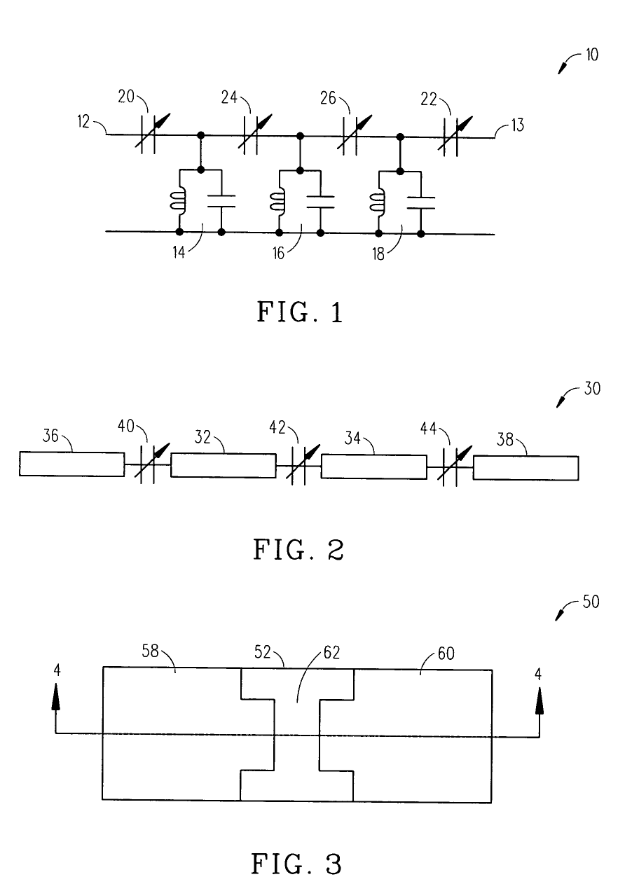

Referring to the drawings, FIG. 1 is a schematic representation of a lumped element tunable bandwidth band-pass filter 10 constructed in accordance with this invention. Filter 10 includes an input 12, an output 13 and a plurality of resonators 14, 16, 18. A first voltage tunable dielectric access varactor 20 couples input 12 with resonator 14. A second voltage tunable access dielectric varactor 22 couples output 13 with resonator 18. Additional intercavity varactors 24, 26 are connected between adjacent resonators 14, 16, 18. Each of voltage tunable access varactors 20, 22 and each of voltage tunable intercavity or varactors 24, 26 includes a voltage tunable dielectric material having a dielectric constant that varies with an applied control voltage, also called a bias voltage. By changing the control voltage for a respective varactor 20, 22, 24, 26, the capacitance of the respective varactor 20, 22, 24, 26 changes.

In tunable bandwidth bandpass filter 10 (FIG. 1), the coupling between adjacent resonators 14, 16, 18 is achieved by a variable intercavity capacitor or varactor 24, 26. By changing the bias voltage of a respective intercavity varactor 24, 26 its capacitance value will change which provides a change in coupling factor. Similarly, access coupling of input 12 through access varactor 20 or access coupling of output 13 through access varactor 22 can be controlled by tuning appropriate access varactors 20, 22. Bandwidth of filter 10 is defined by intercavity coupling (i.e., coupling among resonators 14, 16, 18), as well as access coupling through access varactors 20, 22 Therefore, by tuning these various couplings the bandwidth of filter 10 can be tuned or changed.

When varactors 20, 22, 24, 26 are biased, their capacitance values are smaller, resulting in smaller coupling factors. A consequence of such smaller coupling factors is that filter 10 exhibits a narrower bandwidth. Resonators and coupling structures appropriate for employment in filter 10 may be embodied in different topologies. For example, resonators may be configured as lumped elements for high frequency (HF) applications. Coaxial cavities or transmission lines based on coaxial, microstrip, or stripline lines can be used for low frequency RF applications. Dielectric resonators or waveguides can be used for higher frequency applications. The coupling mechanism between resonators can be capacitive or inductive.

FIG. 2 shows another example of a tunable bandwidth filter 30 constructed in accordance with this invention using microstrip technology. Filter 30 includes two edge coupled microstrip line resonators 32, 34. An input microstrip line resonator 36 is provided for delivering a signal to filter 30. An output microstrip line resonator 38 is provided for receiving a signal from filter 30. In order to tune the bandwidth of filter 30, the coupling factor between resonators, as well as, between input/output transmission lines and the resonators should be changed. Tunable varactors 40, 42 and 44 are provided for coupling resonators 32, 34, 36, 38. Varactors 40, 42, 44 are coupled between resonators 32, 34, 36, 38. Changing bias voltage to a respective varactor 40, 42, 44 changes the capacitance value for the respective varactor 40, 42, 44 which changes the coupling factor for the respective varactor 40, 42, 44. By effecting changes in the coupling factors of respective varactors 40, 42, 44, the bandwidth of filter 30 may be altered. Both the access coupling and intercavity couplings are capacitive in this exemplary embodiment illustrated in FIG. 2.

As illustrated by exemplary filters 10, 30 (FIGS. 1 and 2), electrically tunable bandwidth filters use electronically tunable varactors to tune intercavity coupling, thus varying the coupling factor between the resonators, as well as, access coupling. The varactor capacitance may be variously changed among respective varactors by applying different bias voltages to different varactors. In such manner the coupling factors of various varactors may be varied, and bandwidth of the filter in which the varactors are employed may be adjusted.

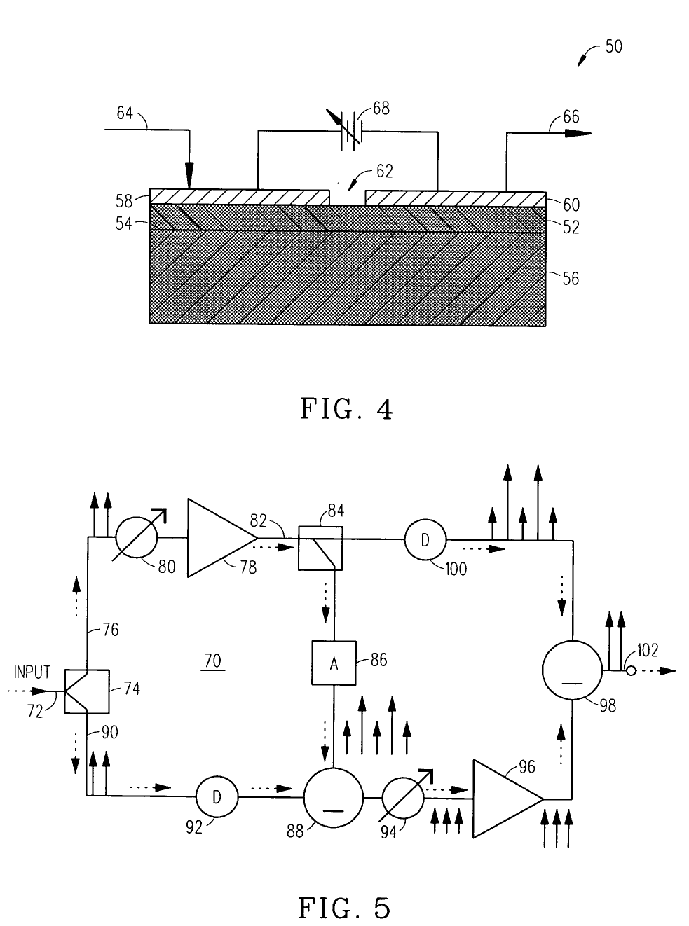

FIG. 3 is a top plan view of a varactor 50 that can be used in the filters of this invention. FIG. 4 is a cross-sectional view of the varactor of FIG. 3, taken along section 4-4 of FIG. 3. In FIGS. 3 and 4, a varactor 50 includes a layer 52 of voltage tunable dielectric material positioned on a surface 54 of a low loss, low dielectric substrate 56. A pair of electrodes 58, 60 are positioned on layer 52 and separated by a gap 62. An input line 64 is connected with electrode 58 and an output line 66 is connected with electrode 60. A variable DC voltage source 68 is connected between electrodes 58, 60 to supply a control voltage to varactor 50. By changing the control voltage provided by voltage source 58, the capacitance of varactor 50 can be altered.

Filters configured according to the teachings of the present invention (e.g., filter 10, FIG. 1; filter 30, FIG. 2; filter 50, FIGS. 3 and 4) have low insertion loss, fast tuning speed, high power-handling capability, high IP3 and low cost in the microwave frequency range. Compared to the semiconductor diode varactors, voltage-controlled tunable dielectric capacitors have higher Q factors, higher power-handling and higher IP3. Voltage-controlled tunable dielectric capacitors (e.g., varactors 20, 22, 24, 26, FIG. 1; varactors 40, 42, 44, FIG. 2; varactor 50, FIG. 3) have a capacitance that varies approximately linearly with applied voltage and can achieve a wider range of capacitance values than is possible with semiconductor diode varactors.

Filters 10, 30, 50 described above can also serve as tunable delay filters. Tunable delay filters can be used in various devices, such as feed forward amplifiers. FIG. 5 is a schematic representation of feed forward amplifier 70 including tunable delay filters in accordance with this invention. A radio frequency (RF) signal is input to an input port 72 and split by a signal splitter 74 into first and second parts. The first part on a line 76 goes to a main amplifier 78 via a gain and phase adjustment device 80. The output of main amplifier 78 on line 82 is a high level, distorted carrier signal. A portion of this amplified and distorted carrier signal is extracted using a directional coupler 84 and provided to a carrier cancellation device 88 via an attenuator 86.

The second part of the RF signal received at signal splitter 74 is directed on a line 90 to carrier cancellation device 88 via a delay device 92. Delay device 92 is configured to phase match signals arriving at carrier cancellation device 88 from lines 76, 90. The signal arriving at carrier cancellation device 88 goes to a main amplifier 78 via a gain and phase adjustment device 80.

The output of carrier cancellation device 88 is a low level error or distortion signal. This signal, after passing through another gain and phase adjustment device 94, is amplified by a low power amplifier 96. An output signal from low power amplifier 96 is provided to a subtractor device 98. A main distorted signal is provided to subtractor 98 from directional coupler 84 via a delay device 100. Subtractor 98 produces a difference signal at an output 102 representing the difference between signals provided to subtractor 98 from delay device 100 and from low power amplifier 96. The difference signal appearing at output 102 the desired non-distorted output carrier signal.

One or both of the delay devices 92, 100 in FIG. 5 can be a tunable delay filter. By changing the bias voltage of varactor 42 in filter 30 (FIG. 2), for example, its capacitance value will change which provides a change in its coupling factor. Similarly the input/output access coupling for filter 30 can be varied by tuning the corresponding varactors 40, 42. Changing the coupling factors of filter 30 changes the bandwidth, which will result in changing the group delay. Therefore, by tuning the coupling varactors 40, 42 the group delay of filter 30 can be changed.

Resonators and coupling structures can be embodied in different topologies. For example, resonators can be lumped elements for HF applications; coaxial cavities or transmission lines based on coaxial lines, microstrip lines, or stripline lines can be used for low frequency RF applications; and dielectric resonators or waveguides can be used for higher frequency applications. Coupling structures can be capacitive or inductive. The above described structures are only examples. Electronically tunable varactors can be used to tune the coupling factors and hence the bandwidth of any bandpass filter design to provide variable group delay.

The invention also encompasses a method of delaying an electrical signal, the method comprising the steps of: providing first and second resonators, an input, a first tunable dielectric varactor connecting the input to the first resonator, an output, a second tunable dielectric varactor connecting the second resonator to the output, and a third tunable dielectric varactor connecting the first and second resonators; coupling the electrical signal to the input; and extracting a delayed version of the electrical signal at the output.

The tunable dielectric varactors in the preferred embodiments of the present invention can include a low loss (Ba,Sr)TiO.sub.3-based composite film. The typical Q factor of the tunable dielectric capacitors is 200 to 500 at 2 GHz with capacitance ratio (C.sub.max/C.sub.min) around 2. A wide range of capacitance of the tunable dielectric capacitors is variable, say 0.1 pF to 10 pF. The tuning speed of the tunable dielectric capacitor is less than 30 ns. The practical tuning speed is determined by auxiliary bias circuits. The tunable dielectric capacitor may be a packaged two-port component, in which tunable dielectric material can be voltage-controlled. The tunable film may preferably be deposited on a substrate, such as MgO, LaAlO.sub.3, sapphire, Al.sub.2O.sub.3 and other dielectric substrates. An applied voltage produces an electric field across the tunable dielectric, which produces a change in the capacitance of the tunable dielectric capacitor.

Tunable dielectric materials have been described in several patents. Barium strontium titanate (BaTiO.sub.3--SrTiO.sub.3), also referred to as BSTO, is used for its high dielectric constant (200-6,000) and large change in dielectric constant with applied voltage (25-75 percent with a field of 2 Volts/micron). Tunable dielectric materials including barium strontium titanate are disclosed in U.S. Pat. No. 5,427,988 by Sengupta, et al. entitled “Ceramic Ferroelectric Composite Material—BSTO—MgO”; U.S. Pat. No. 5,635,434 by Sengupta, et al. entitled “Ceramic Ferroelectric Composite Material—BSTO-Magnesium Based Compound”; U.S. Pat. No. 5,830,591 by Sengupta, et al. entitled “Multilayered Ferroelectric Composite Waveguides”; U.S. Pat. No. 5,846,893 by Sengupta, et al. entitled “Thin Film Ferroelectric Composites and Method of Making”; U.S. Pat. No. 5,766,697 by Sengupta, et al. entitled “Method of Making Thin Film Composites”; U.S. Pat. No. 5,693,429 by Sengupta, et al. entitled “Electronically Graded Multilayer Ferroelectric Composites”; U.S. Pat. No. 5,635,433 by Sengupta entitled “Ceramic Ferroelectric Composite Material BSTO—ZnO”; U.S. Pat. No. 6,074,971 by Chiu et al. entitled “Ceramic Ferroelectric Composite Materials with Enhanced Electronic Properties BSTO—Mg Based Compound-Rare Earth Oxide”. These patents are incorporated herein by reference.

Barium strontium titanate of the formula Ba.sub.xSr.sub.1-xTiO.sub.-3 is a preferred electronically tunable dielectric material due to its favorable tuning characteristics, low Curie temperatures and low microwave loss properties. In the formula Ba.sub.xSr.sub.1-xTiO.sub.3, x can be any value from 0 to 1, preferably from about 0.15 to about 0.6. More preferably, x is from 0.3 to 0.6.

Other electronically tunable dielectric materials may be used partially or entirely in place of barium strontium titanate. An example is Ba.sub.xCa.sub.1-xTiO.sub.3, where x is in a range from about 0.2 to about 0.8, preferably from about 0.4 to about 0.6. Additional electronically tunable ferroelectrics include Pb.sub.xZr.sub.1-xTiO.sub.3 (PZT) where x ranges from about 0.0 to about 1.0, Pb.sub.xZr.sub.1-xSrTiO-.sub.3 where x ranges from about 0.05 to about 0.4, KTa.sub.xNb.sub.1-xO.sub.3 where x ranges from about 0.0 to about 1.0, lead lanthanum zirconium titanate (PLZT), PbTiO.sub.3, BaCaZrTiO.sub.3, NaNO.sub.3, KNbO.sub.3, LiNbO.sub.3, LiTaO.sub.3, PbNb.sub.2O.sub.6, PbTa.sub.2O.sub.6, KSr(NbO.sub.3) and NaBa.sub.2(NbO.sub.3).sub.5KH.sub.2-PO.sub.4, and mixtures and compositions thereof. Also, these materials can be combined with low loss dielectric materials, such as magnesium oxide (MgO), aluminum oxide (Al.sub.2O.sub.3), and zirconium oxide (ZrO.sub.2), and/or with additional doping elements, such as manganese (MN), iron (Fe), and tungsten (W), or with other alkali earth metal oxides (i.e. calcium oxide, etc.), transition metal oxides, silicates, niobates, tantalates, aluminates, zirconnates, and titanates to further reduce the dielectric loss.

In addition, the following U.S. patent applications, assigned to the assignee of this application, disclose additional examples of tunable dielectric materials: U.S. application Ser. No. 09/594,837 filed Jun. 15, 2000, entitled “Electronically Tunable Ceramic Materials Including Tunable Dielectric and Metal Silicate Phases”; U.S. application Ser. No. 09/768,690 filed Jan. 24, 2001, entitled “Electronically Tunable, Low-Loss Ceramic Materials Including a Tunable Dielectric Phase and Multiple Metal Oxide Phases”; U.S. application Ser. No. 09/882,605 filed Jun. 15, 2001, entitled “Electronically Tunable Dielectric Composite Thick Films And Methods Of Making Same”; U.S. application Ser. No. 09/834,327 filed Apr. 13, 2001, entitled “Strain-Relieved Tunable Dielectric Thin Films”; and U.S. provisional application Ser. No. 60/295,046 filed Jun. 1, 2001 entitled “Tunable Dielectric Compositions Including Low Loss Glass Frits”. These patent applications are incorporated herein by reference.

The tunable dielectric materials can also be combined with one or more non-tunable dielectric materials. The non-tunable phase(s) may include MgO, MgAl.sub.2O.sub.4, MgTiO.sub.3, Mg.sub.2SiO.sub.4, CaSiO.sub.3, MgSrZrTiO.sub.6, CaTiO.sub.3, Al.sub.2O.sub.3, SiO.sub.2 and/or other metal silicates such as BaSiO.sub.3 and SrSiO.sub.3. The non-tunable dielectric phases may be any combination of the above, e.g., MgO combined with MgTiO.sub.3, MgO combined with MgSrZrTiO.sub.6, MgO combined with Mg.sub.2SiO.sub.4, MgO combined with Mg.sub.2SiO.sub.4, Mg.sub.2SiO.sub.4 combined with CaTiO.sub.3 and the like.

Additional minor additives in amounts of from about 0.1 to about 5 weight percent can be added to the composites to additionally improve the electronic properties of the films. These minor additives include oxides such as zirconnates, tannates, rare earths, niobates and tantalates. For example, the minor additives may include CaZrO.sub.3, BaZrO.sub.3, SrZrO.sub.3, BaSnO.sub.3, CaSnO.sub.3, MgSnO.sub.3, Bi.sub.2O.sub.3/2SnO.sub.2, Nd.sub.2O.sub.3, Pr.sub.7O.sub.11, Yb.sub.2O.sub.3, Ho.sub.2O.sub.3, La.sub.2O.sub.3, MgNb.sub.2O.sub.6, SrNb.sub.2O.sub.6, BaNb.sub.2O.sub.6, MgTa.sub.2O.sub.6, BaTa.sub.2O.sub.6 and Ta.sub.2O.sub.3.

Thick films of tunable dielectric composites can comprise Ba.sub.1-xSr.sub.xTiO.sub.3, where x is from 0.3 to 0.7 in combination with at least one non-tunable dielectric phase selected from MgO, MgTiO.sub.3, MgZrO.sub.3, MgSrZrTiO.sub.6, Mg.sub.2SiO.sub.4, CaSiO.sub.3, MgAl.sub.2O.sub.4, CaTiO.sub.3, Al.sub.2O.sub.3, SiO.sub.2, BaSiO.sub.3 and SrSiO.sub.3. These compositions can be BSTO and one of these components or two or more of these components in quantities from 0.25 weight percent to 80 weight percent with BSTO weight ratios of 99.75 weight percent to 20 weight percent.

The electronically tunable materials can also include at least one metal silicate phase. The metal silicates may include metals from Group 2A of the Periodic Table, i.e., Be, Mg, Ca, Sr, Ba and Ra, preferably Mg, Ca, Sr and Ba. Preferred metal silicates include Mg.sub.2SiO.sub.4, CaSiO.sub.3, BaSiO.sub.3 and SrSiO.sub.3. In addition to Group 2A metals, the present metal silicates may include metals from Group 1A, i.e., Li, Na, K, Rb, Cs and Fr, preferably Li, Na and K. For example, such metal silicates may include sodium silicates such as Na.sub.2SiO.sub.3 and NaSiO.sub.3-5H.sub.2O, and lithium-containing silicates such as LiAlSiO.sub.4, Li.sub.2SiO.sub.3 and Li.sub.4SiO.sub.4. Metals from Groups 3A, 4A and some transition metals of the Periodic Table may also be suitable constituents of the metal silicate phase.

Additional metal silicates may include Al.sub.2Si.sub.2O.sub.7, ZrSiO.sub.4, KalSi.sub.3O.sub.8, NaAlSi.sub.3O.sub.8, CaAl.sub.2Si.sub.2O.sub.8, CaMgSi.sub.2O.sub.6, BaTiSi.sub.3O.sub.9 and Zn.sub.2SiO.sub.4. The above tunable materials can be tuned at room temperature by controlling an electric field that is applied across the materials.

In addition to the electronically tunable dielectric phase, the electronically tunable materials can include at least two additional metal oxide phases. The additional metal oxides may include metals from Group 2A of the Periodic Table, i.e., Mg, Ca, Sr, Ba, Be and Ra, preferably Mg, Ca, Sr and Ba. The additional metal oxides may also include metals from Group 1A, i.e., Li, Na, K, Rb, Cs and Fr, preferably Li, Na and K. Metals from other Groups of the Periodic Table may also be suitable constituents of the metal oxide phases. For example, refractory metals such as Ti, V, Cr, Mn, Zr, Nb, Mo, Hf, Ta and W may be used. Furthermore, metals such as Al, Si, Sn, Pb and Bi may be used. In addition, the metal oxide phases may comprise rare earth metals such as Sc, Y, La, Ce, Pr, Nd and the like.

The additional metal oxides may include, for example, zirconnates, silicates, titanates, aluminates, stannates, niobates, tantalates and rare earth oxides.

Preferred additional metal oxides include Mg.sub.2SiO.sub.4, MgO, CaTiO.sub.3, MgZrSrTiO.sub.6, MgTiO.sub.3, MgAl.sub.2O.sub.4, WO.sub.3, SnTiO.sub.4, ZrTiO.sub.4, CaSiO.sub.3, CaSnO.sub.3, CaWO.sub.4, CaZrO.sub.3, MgTa.sub.2O.sub.6, MgZrO.sub.3, MnO.sub.2, PbO, Bi.sub.2O.sub.3 and La.sub.2O.sub.3. Particularly preferred additional metal oxides include Mg.sub.2SiO.sub.4, MgO, CaTiO.sub.3, MgZrSrTiO.sub.6, MgTiO.sub.3, MgAl.sub.2O.sub.4, MgTa.sub.2O.sub.6 and MgZrO.sub.3.

The additional metal oxide phases are typically present in total amounts of from about 1 to about 80 weight percent of the material, preferably from about 3 to about 65 weight percent, and more preferably from about 5 to about 60 weight percent. In one preferred embodiment, the additional metal oxides comprise from about 10 to about 50 total weight percent of the material. The individual amount of each additional metal oxide may be adjusted to provide the desired properties. Where two additional metal oxides are used, their weight ratios may vary, for example, from about 1:100 to about 100:1, typically from about 1:10 to about 10:1 or from about 1:5 to about 5:1. Although metal oxides in total amounts of from 1 to 80 weight percent are typically used, smaller additive amounts of from 0.01 to 1 weight percent may be used for some applications.

In one embodiment, the additional metal oxide phases may include at least two Mg-containing compounds. In addition to the multiple Mg-containing compounds, the material may optionally include Mg-free compounds, for example, oxides of metals selected from Si, Ca, Zr, Ti, Al and/or rare earths. In another embodiment, the additional metal oxide phases may include a single Mg-containing compound and at least one Mg-free compound, for example, oxides of metals selected from Si, Ca, Zr, Ti, Al and/or rare earths. The high Q tunable dielectric capacitor utilizes low loss tunable substrates or films.

To construct a tunable device, the tunable dielectric material can be deposited onto a low loss substrate. In some instances, such as where thin film devices are used, a buffer layer of tunable material, having the same composition as a main tunable layer, or having a different composition can be inserted between the substrate and the main tunable layer. The low loss dielectric substrate can include magnesium oxide (MgO), aluminum oxide (Al.sub.2O.sub.3), and lanthium oxide (LaAl.sub.2O.sub.3).

When the bias voltage or bias field is changed, the dielectric constant of the voltage tunable dielectric material (di-elect cons..sub.r) will change accordingly, which will result in a tunable varactor. Compared to semiconductor varactor based tunable filters, the tunable dielectric capacitor based tunable filters of this invention have the merits of lower loss, higher power-handling, and higher IP3, especially at higher frequencies (>10 GHz). It is observed that between 50 and 300 volts a nearly linear relation exists between Cp and applied Voltage.

In microwave applications the linear behavior of a dielectric varactor is very much appreciated, since it will assure very low Inter-Modulation Distortion and consequently a high IP3 (Third-order Intercept Point). Typical IP3 values for diode varactors are in the range 5 to 35 dBm, while that of a dielectric varactor is greater than 50 dBm. This will result in a much higher RF power handling capability for a dielectric varactor.

Another advantage of dielectric varactors compared to diode varactors is the power consumption. The dissipation factor for a typical diode varactor is in the order of several hundred milliwatts, while that of the dielectric varactor is about 0.1 mW.

Diode varactors show high Q only at low microwave frequencies so their application is limited to low frequencies, while dielectric varactors show good Q factors up to millimeter wave region and beyond (up to 60 GHz).

Tunable dielectric varactors can also achieve a wider range of capacitance (from 0.1 pF all the way to several .mu.F), than is possible with diode varactors. In addition, the cost of dielectric varactors is less than diode varactors, because they can be made more cheaply.

High frequency, radio frequency, and microwave bandpass filters of this invention include a number of resonators and some coupling structures. The resonators can be lumped elements, any type of transmission lines, dielectric resonators, waveguides, or other resonating structures. The coupling mechanism between the adjacent resonators as well as the access transmission line and first and last resonators can be tuned electronically by using tunable dielectric varactors. Tuning the coupling factors of the bandpass filter results in tunable bandwidth filter.

Electronically tunable dielectric varactors may be used to make tunable delay filters. The invention also relates to compact, high performance, low loss, and low cost tunable delay filters. These compact tunable delay filters are increasingly being used in feed-forward or pre-distortion technologies used in high power amplifiers in wireless communication base stations and other communication systems. The high Q varactor using low loss tunable dielectric material films leads to high performance tunable delay filters with significant advantages over fixed delay filters and coaxial cable delay lines.

The electronically tunable delay filters of this invention use electronically tunable varactors to tune the group delay of the filter. When the varactor capacitance is changed by applying different bias voltages, the coupling factors between the filter resonators are varied, which result in a change in filter group delay value. Electrically tunable delay filters based on dielectric varactors have important advantages such as high Q, small size, lightweight, low power consumption, simple control circuits, and fast tuning capability. Compared with semiconductor diode varactors, dielectric varactors have the merits of lower loss, higher power-handling, higher IP3, faster tuning speed, and lower cost.

The tunable delay filters include a number of resonators and some coupling structures. The resonators can be lumped element, any type of transmission line, dielectric resonator, waveguide, or another resonator structure. The coupling mechanism between the adjacent resonators as well as the access transmission line and first and last resonators can be tuned electronically by using voltage tunable dielectric varactors. Tuning the coupling factors of the bandpass filter will result in tunable delay filter. Some filter examples are provided, but the patent is not limited to those structures.

This invention provides an effective way of designing a tunable delay filter. When used in a feed forward amplifier the filters provide an easy way of inducing delay as well as tuning delay to obtain distortion free output signals from power amplifiers. Improved tuning delay can result in better modulated signals. Tunable delay filters can reduce the system cost and significantly improve the quality of radio link.

This invention provides electrically tunable bandwidth and tunable delay filters having high Q, small size, light weight, low power consumption, simple control circuits, and fast tuning capability.

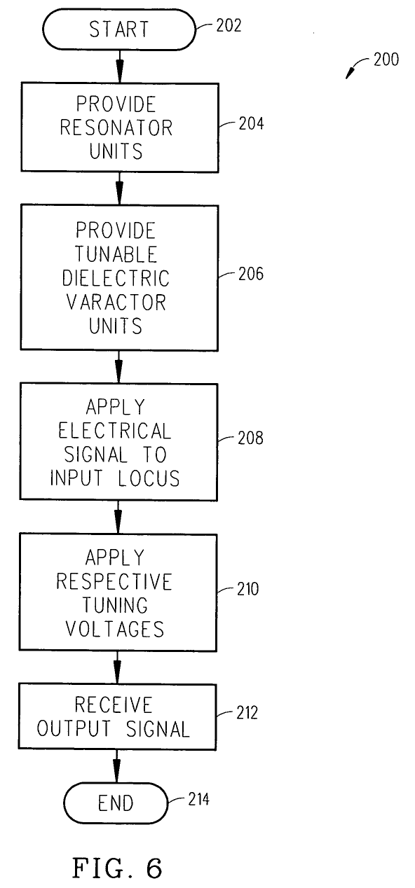

FIG. 6 is a flow diagram illustrating the method of the present invention. In FIG. 6, a method 200 for delaying an electrical signal begins at a START locus 202. Method 200 continues with providing a plurality of resonator units coupled between an input locus and an output locus, as indicated by a block 204.

Method 200 continues with providing a plurality of tunable dielectric varactor units, as indicated by a block 206. Respective individual varactor units of the plurality of varactor units are coupled between respective pairs of the plurality of resonator units, coupled between the plurality of resonator units and the input locus, and coupled between the plurality of resonator units and the output locus. Each respective individual varactor unit includes a substrate, a layer of voltage tunable dielectric material established in a first land on the substrate, a first electrode structure for receiving an electrical signal established in a second land on the first land, and a second electrode structure for receiving an electrical signal established in a third land on the first land. The first land and the second land are separated by a gap.

Method 200 continues with applying the electrical signal to the input locus, as indicated by a block 208. Method 200 continues with applying a respective tuning voltage to the first electrode structure and the second electrode structure of each respective varactor unit, as indicated by a block 210. Each respective varactor unit exhibits a respective capacitance. The respective capacitance varies in response to the respective tuning voltage.

Method 200 continues with receiving an output signal at the output locus, as indicated by a block 212. The output signal is delayed with respect to the electrical signal. Method 200 then terminates, as indicated by an END locus 214.

Another application where a tunable delay line may be used in an embodiment of the present invention is in a feed forward amplifier with multiple cancellation loops capable of reducing intermodulation distortion and receives band noise. The use of Feedforward technique to reduce intermodulation distortion, caused by the power amplifier in the transmit (Tx) path is well known. The above articulated tunable delay line used in the feed forward cancellation loop, based on BST tunable dielectric material, has been shown to provide significant reduction of intermodulation signals. In an embodiment of the present invention, by adding at least one additional loop, the noise signal in the Rx band may be reduced which helps relax the rejection requirement of the Tx filter in the Duplexer and decreases the insertion loss, hence increase the output power.

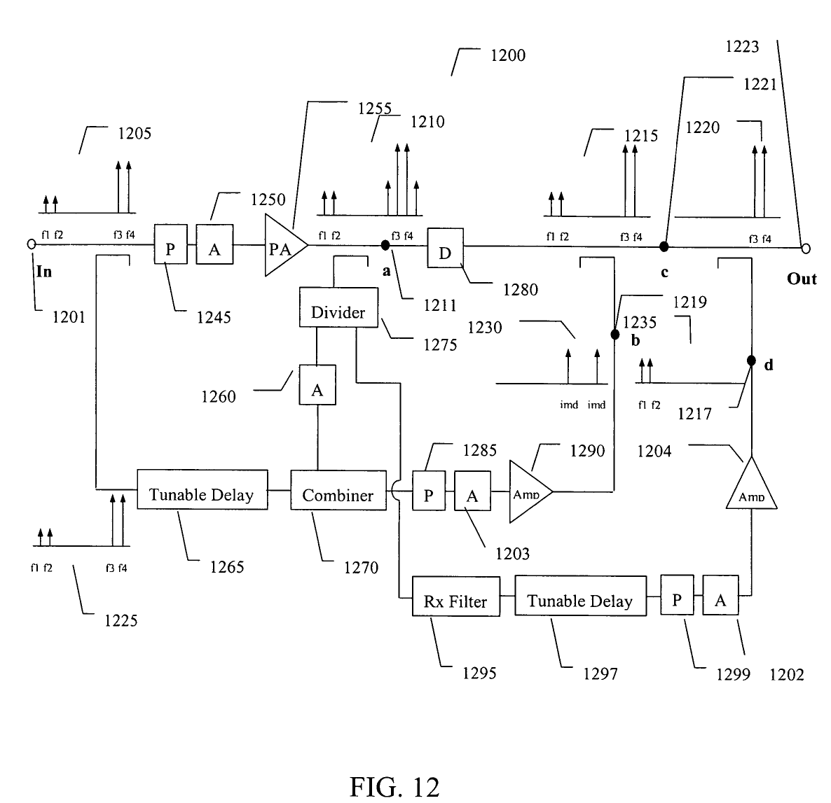

When amplifying the Tx band signal, Rx band noise signals are also amplified and transferred to the duplexer 1280 of FIG. 12. These signals may enter the receiver without attenuation and will decrease signal to noise ratio (SNR) of the receiver. This could be avoided by increasing the isolation between Tx and Rx in the Duplexer, but it would require front end Tx filter with more rejection, with associated higher insertion loss. In an embodiment of the present invention, an alternative approach is to use at least one additional loop and in one embodiment a second loop in the feedforward amplifier to reduce this noise.

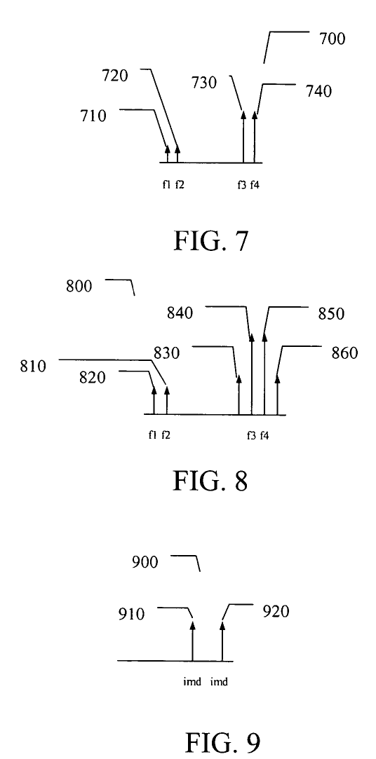

Turning now to the figures, FIGS. 7-12 are shown generally at 700, 800, 900, 1000, 1100, 1200. FIG. 7 illustrates a signal spectrum at the input which includes a transmit signal and receive noise of one embodiment of the present invention with the input signal in the transmit path which contains Tx signal, and some noise in the Rx band with f1 710 and f2 720 being two tones of noise in Rx band and f3 730 and f4 740 are two tones in Tx band. FIG. 8 illustrates a signal spectrum at point “a” of FIG. 12 including a transmit signal 840 and 850 and receive noise 810 and 820 and intermodulation signals 830 and 860 one embodiment of the present invention.

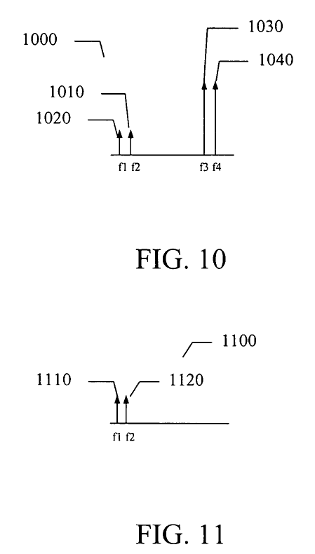

FIG. 9 illustrates the signal spectrum at point “b” of FIG. 12 and intermodulation signals 910 and 920 of one embodiment of the present invention. FIG. 10 illustrates the Signal spectrum at point “c” of FIG. 12 with Transmit signal 1030 and 1040 and Receive noise 1010 and 1020 amplified of one embodiment of the present invention. FIG. 11 illustrates the signal spectrum at point “d” of FIG. 12 with receive noise 1110 and 1120 of one embodiment of the present invention.

Turning now to FIG. 12 is an illustration of a feed forward power amplifier capable of reducing intermodulation distortion and receive noise of one embodiment of the present invention. At input 1201 the input signal in the transmit path which contains Tx signal, and some noise in the Rx band (illustrated at 1205). This signal, after some amplitude 1245 and phase 1250 adjustment, will reach the main power amplifier, PA 1255. The PA 1255 will amplify the Tx signal, the Rx noise, and will generate some intermodulation signals, as shown by the spectrum at point a 1211, with signal vectors shown at 1210.

A portion of signal “a” 1211 is coupled off and then divided in two halves by Wilkinson divider 1275, although the present invention is not limited to any particular divider. One half will go to the combiner 1270 after some amplitude 1260 adjustments. At the input 1201, a portion of the input signal (signal vector shown at 1225) will be coupled off and after passing through the tunabale delay line 1265 will be subtracted from the signal coming from point a 1211. The output of the combiner 1270 will therefore contain only the intermodulation signal. This is achieved when the two signals reaching the combiner 1270 have exactly the same amplitude, and are out of phase. The presence of tunable delay line 1265 is necessary to achieve wide band cancellation. This signal, after some amplitude 1203 and phase 1285 adjustments will be amplified by an error amplifier, Amp 1290, shown at point b 1219. Intermodulation and f1 and f2 signal vectors 1230 and 1235 and shown at point b 1219.

The signal at point “b” 1219 will then be coupled, or subtracted from signal “a” 1211 to give signal “c” 1221 without intermodulation distortion. Signal vectors for point “c” is shown at 1215 and 1220. The cancellation is achieved, when the amplitude of this signal is exactly equal to the amplitude of intermodulation signal at point “a” 1211 with 180 phase shift. It is observed that the noise in the receive band, f1 and f2, are still present at point “c” 1221 as shown at 1215. The purpose of the second loop is to eliminate this noise, as described below.

The other half of signal “a” 1211 from Divider 1275 will go through a bandpass filter 1295 at the frequency of Rx. This filter 1295 will reject Tx signal and intermodulation signals. Alternatively, a notch filter could be used to reject the Tx spectrum and it is understood that the present invention is not limited to any particular types of filters. This signal, after going through a tunable delay line 1297, phase shifter P 1299, and attenuator A 1202, will be amplified using an error amplifier Amp 1204. Again, the role of tunable delay line is crucial in achieving wide band cancellation and to compensate for any temperature drift in other components of the loop. The signal at point “d” 1217 only contains the Rx noise signal f1 and f2 1219.

Similar to the first cancellation loop, the signal at point “d” 1217 will be subtracted from the signal at pint “c” 1221 resulting in the output transmit signal 1223 containing only the Tx tones 1220.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

What is claimed is:

1. An apparatus, comprising:
a feed forward amplifier capable of receiving an input signal; and
a plurality of cancellation loops associated with said feed forward amplifier, wherein at least one of said plurality of cancellation loops includes a tunable delay line enabling the reduction of intermodulation distortion and receive band noise when outputs from said plurality of cancellation loops are combined with said input signal to said feed forward amplifier.

2. The apparatus of claim 1, wherein said plurality of cancellation loops are two cancellations loops and a tunable delay line is included in both of said cancellation loops.

3. The apparatus of claim 1, wherein said tunable delay line is a voltage tunable delay line.

4. The apparatus line of claim 3, wherein said tunable delay line includes a voltage tunable dielectric capacitor to facilitate the control of said tunable delay.

5. The apparatus of claim 4, wherein said voltage tunable dielectric capacitor includes a layer of voltage tunable dielectric material positioned on a surface of a low loss, low dielectric substrate.

6. The apparatus of claim 5, wherein said voltage tunable dielectric capacitor further includes a pair of electrodes positioned on said layer of voltage tunable dielectric material and separated by a gap, with an input line connected with a first electrode of said pair of electrodes and an output line connected with a second electrode of said pair of electrodes.

7. The apparatus of claim 6, wherein said voltage tunable dielectric capacitor further includes a variable DC voltage source connected between said pair of electrodes to supply a control voltage to said voltage tunable dielectric capacitor.

8. The apparatus of claim 2, further comprising an input signal, said input signal including a receive band noise component and an intermodulation interference component and wherein the enabling of the reduction of intermodulation distortion and receive band noise when said plurality of cancellation loops are combined is accomplished by said tunable delay line of said first cancellation loop delaying the noise component by 180 degrees of said input signal and said delay line of said second cancellation loop delaying the intermodulation interference component by 180 degrees such that when the input signal and said signals from said first and said second cancellation loops are combined, the noise signal component and the intermodulation signal component are cancelled from said input signal.

9. A method of reducing intermodulation distortion and receive band noise in a signal that is input into a feed forward amplifier, comprising:
applying a first cancellation loop to said input signal, said first cancellation loop including a tunable delay line capable of delaying a noise component to said input signal;
applying a second cancellation loop to said input signal, said second cancellation loop including a tunable delay line capable of delaying an intermodulation noise component to said input signal; and
combining said input signal and the output of said first cancellation loop and the output of said second cancellation loop to produce an output signal with reduced noise and intermodulation interference.

10. The method of claim, wherein said tunable delay line is a voltage tunable delay line.

11. The method line of claim 10, wherein said tunable delay line includes a voltage tunable dielectric capacitor to facilitate the control of said tunable delay.

12. The method of claim 11, wherein said voltage tunable dielectric capacitor includes a layer of voltage tunable dielectric material positioned on a surface of a low loss, low dielectric substrate.

13. The method of claim 12, wherein said voltage tunable dielectric capacitor further includes a pair of electrodes positioned on said layer of voltage tunable dielectric material and separated by a gap, with an input line connected with a first electrode of said pair of electrodes and an output line connected with a second electrode of said pair of electrodes.

14. The method of claim 12, wherein said voltage tunable dielectric capacitor further includes a variable DC voltage source connected between said pair of electrodes to supply a control voltage to said voltage tunable dielectric capacitor.

15. The method of claim 9, further comprising passing said signal through a passband filter prior to entering said tunable delay in said second cancellation loop.

16. A system, comprising:
a feed forward amplifier with an input signal and an output signal; and
a plurality of cancellation loops integral to said feed forward amplifier, wherein each of said plurality of cancellation loops contains a tunable delay line capable of adjusting the time delay and phase of said input signal and recombining with said input signal such that any interference included in said input signal or generated by said feed forward amplifier is removed prior to said output signal.

17. The system of claim 16, wherein said interference included in said input signal or generated by said feed forward amplifier is receiver noise or intermodulation interference.

18. The system of claim 16, wherein said plurality of cancellation loops are two cancellations loops and a tunable delay line is included in both of said cancellation loops.

19. The system of claim 18, wherein said tunable delay line is a voltage tunable delay line.

20. The system of claim 19, wherein said tunable delay line includes a voltage tunable dielectric capacitor to facilitate the control of said tunable delay.

21. The system of claim 20, wherein said voltage tunable dielectric capacitor includes a layer of voltage tunable dielectric material positioned on a surface of a low loss, low dielectric substrate.
